(19) United States
(12) Patent Application Publication
(10) Pub. No.: US 2016/0179062 A1
(43) Pub. Date: Jun. 23, 2016

(54) MACHINE DATA MANAGEMENT SYSTEM USING REMOVABLE CONTROLLER

(71) Applicant: Caterpillar Inc., Peoria, IL (US)

(72) Inventor: THIERRY ANDRE MARCHIONE, Hebert City, UT (US)

(73) Assignee: Caterpillar Inc., Peoria, IL (US)

(21) Appl. No.: 14/573,121

(22) Filed: Dec. 17, 2014

(51) Int. Cl. G05B 15/02; G05G 9/047

(52) U.S. Cl. CPC G05B 15/02; G05G 9/047

(57) ABSTRACT

A data management system for a machine is disclosed. The data management system may include a removable control device connectable to the machine and configured to generate control signals for the machine based on operator movement of the removable control device. The removable control device may have a memory module. The data management system may further include an onboard controller in communication with the memory module of the removable control device when the removable control device is connected to the machine. The controller may be configured to communicate data with the memory module.

### TECHNICAL FIELD

The present disclosure is directed to a machine data management system and, more particularly, to a machine data management system using a removable controller.

### BACKGROUND

Mining, construction, and other large scale excavating operations require fleets of digging, loading, and hauling machines to remove and transport excavated material. For such an operation to be profitable, each of the machines must be productively and efficiently operated and maintained. Many factors can influence productivity and efficiency at a worksite including, among other things, site conditions (i.e., rain, snow, ground moisture levels, material composition, visibility, terrain contour etc.), machine conditions (i.e., age, state of disrepair, malfunction, fuel grade in use, etc.), and operator conditions (i.e., experience, skill, dexterity, ability to multi-task, machine or worksite familiarity, fatigue, etc.). Thus, data networks are commonly used to collect and communicate condition data pertaining to machines, operators, sites, etc., which is analyzed to identify and address influences on productivity and efficiency.

An exemplary data network is described in U.S. Pat. No. 8,190,335 (the '335 patent) issued to Vik et al. on May 29, 2012. The '335 patent describes a performance management system for use with a plurality of machines at a common worksite. Each machine has a data acquisition module for collecting performance data and a controller for analyzing the data. The controller determines performance irregularities based on the data and identifies which of a machine condition, operator condition, or site condition is the predominant cause of the irregularity. The data and the cause of the condition from each machine are wirelessly communicated to the other machines at the site and to a central station. In addition to performance data, operator identification information and authorization level can be communicated between the machines and the central station.

While the data network of the '335 patent may effectively collect, analyze, and communicate data between machines and a central station, the data network may be too complex and expensive to implement in a relatively small or medium sized operation. Particularly, the data analysis and long-distance wireless communication components included within each machine may be cost prohibitive if used with a single machine or a small fleet. Further, use of a machine by an unauthorized operator may not be deterred by the system.

The disclosed data management system is directed to overcoming one or more of the problems set forth above and/or other problems of the prior art.

### SUMMARY

In one aspect, the present disclosure is directed to a data management system for a machine. The data management system may include a removable control device connectable to the machine and configured to generate control signals for the machine based on operator movement of the removable control device. The removable control device may have a memory module. The data management system may further include an onboard controller in communication with the memory module of the removable control device when the removable control device is connected to the machine. The controller may be configured to communicate data with the memory module.

In another aspect, the present disclosure is directed to an operator interface device for a machine. The operator interface device may include a base mechanically and electrically connectable to the machine and movable by an operator to generate signals used to control movement of the machine. The operator interface device may also include a memory module embedded within the base and configured to store historical data associated with at least one of the machine and the operator.

In another aspect, the present disclosure is directed to a method fabricating a control device for a machine. The method may include providing a moldable base and allowing an operator to deform the moldable base. The method may further include creating a model of the moldable base after deformation and printing a grip based on the model. The method may include assembling the grip over a permanent base of the control device.

### BRIEF DESCRIPTION OF THE DRAWINGS

FIG. 1 is a diagrammatic representation of an exemplary disclosed data management system;

FIG. 2 is a diagrammatic illustration of an exemplary machine that may form a portion of the system of FIG. 1;

FIG. 3 is a diagrammatic illustration of an exemplary control device that may be used with the machine of FIG. 2;

FIG. 4 is an exploded view illustration of the control device of FIG. 3;

FIG. 5 is a schematic illustration of the data management system of FIG. 1; and

FIG. 6 is a flowchart depicting an exemplary method of fabricating the control device of FIG. 3.

### DETAILED DESCRIPTION

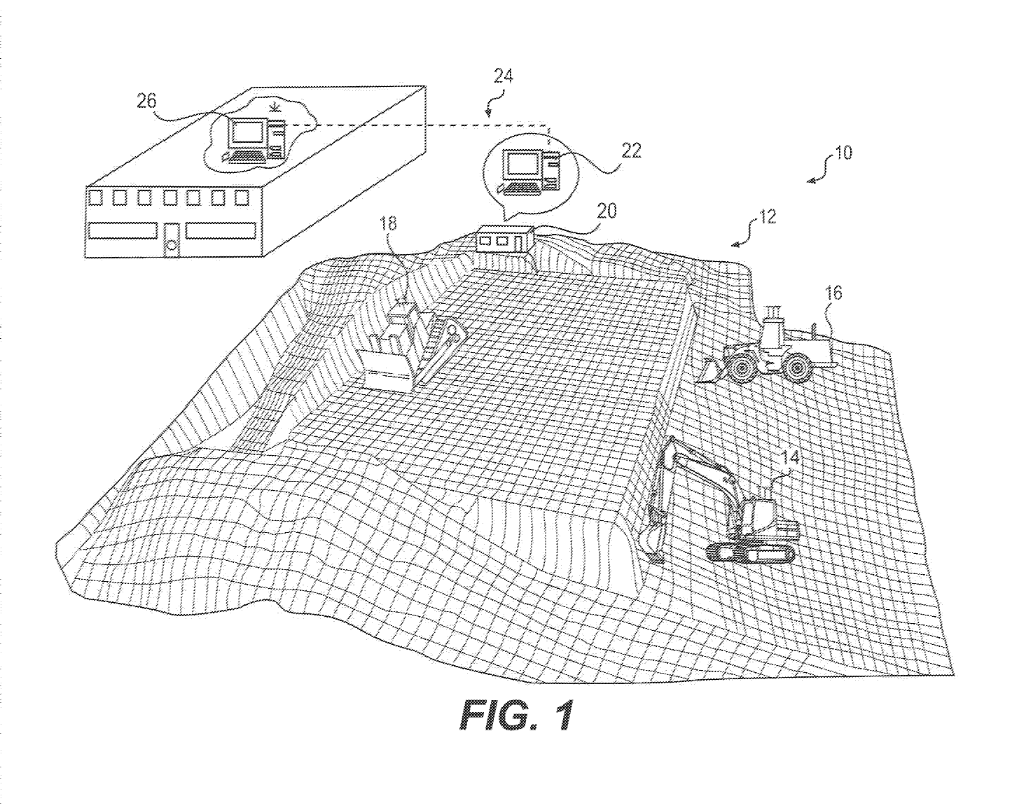

FIG. 1 shows a data management system 10, employed at a worksite 12 such as, for example, an open pit mining operation. As part of the mining operation, different types of machines may be operated to perform different tasks at worksite 12. These machines may include, among others, digging machines 14, loading machines 16, and dozing machines 18. A worksite station 20 may be located at or near worksite 12, and include a worksite computer 22 connected to a data network 24. Data network 24 may be configured to store and analyze various types of data associated with the machines and operators at worksite 12 and other worksites. Worksite computer 22 may be connected to other computers within data network 24, such as a central station computer 26, via a network connection, such as an Ethernet connection, a wireless connection, or any suitable connection. Data network 24 may also be accessible by users having appropriate credentials via the internet.

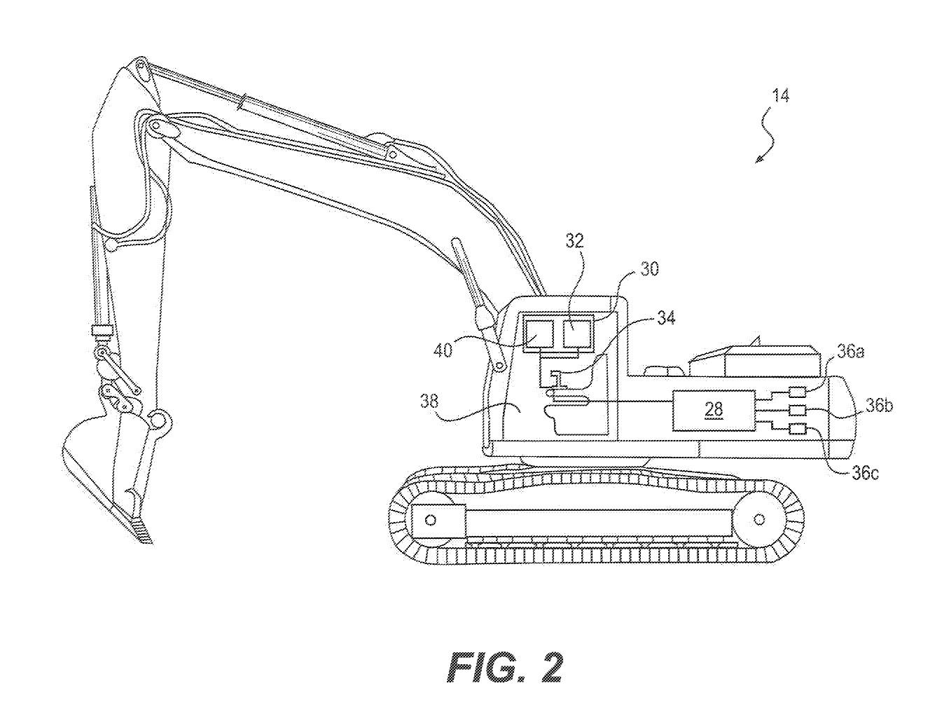

FIG. 2 shows one exemplary digging machine 14 (“machine”) that may be operated at worksite 12. It should be noted that, although the depicted machine may embody a digging machine, the following description may be equally applied to any machine operating at worksite 12. Machine 14 may be configured to record data during its operation that may be transferred to data network 24. This data may include machine identification data, performance data, diagnostic data, operator identification data, worksite data, and other data, which may be automatically monitored from onboard machine 14 and/or manually observed and input by machine operators. Machine 14 may also be configured to process data from data network and share it with parts of machine 14 and with the operator.

To facilitate the sharing of data between machines at worksite 12 to data network 24 (referring to FIG. 1), each machine 14 may include an onboard controller 28, a console 30 having a monitor 32, and a removable control device 34 configured to store and communicate data with machine 14 and with data network 24. Data received by controller 28 and console 30 may be sent off-board to data network 24 by storing the data inside removable control device 34. Removable control device 34 may then be physically removed from machine 14, and connected to a computer (e.g., worksite computer 22 or central station computer 26) or other device in data network 24. Similarly, data from network 24 may be loaded into removable control device 34 by worksite computer 22 or central station computer 26. Removable control device 34 may be reconnected to machine 14 to share data with controller 28 and with the operator via monitor 32. It is contemplated that additional or different modules may be included onboard machine 14, if desired.

Controller 28 may include or otherwise communicate with a plurality of sensors 36a, 36b, 36c distributed throughout machine 14. Sensors 36a-c may be configured to gather data from various components and subsystems thereof. It is contemplated that a greater or lesser number of sensors may be included than that shown in FIG. 1. Sensors 36a-c may be associated with a power source (not shown), a transmission (not shown), a traction device, a work implement, an operator station, and/or other components and subsystems of machine 14. Sensors 36a-c may be configured to provide data gathered from each of the associated components and subsystems. Such data may include engine temperature, engine and/or ground speed or acceleration, fluid characteristics (e.g., levels, contamination, viscosity, temperature, pressure etc.), fuel consumption, fuel type, exhaust emissions, exhaust aftertreatment system characteristics, braking conditions, transmission characteristics, air and/or exhaust pressures and temperatures, engine injection and/or ignition timings, wheel torque, rolling resistance, system voltage, etc. Other pieces of information may be generated or maintained by controller 28 such as, for example, time of day, date, and machine location (global and/or local). Controller 28 may govern, assist, permit, deny, or otherwise control various functions of machine 14. For example, controller 28 may selectively allow startup and/or usage of machine 14 based on data stored within controller 28 or received from data network 24. Controller 28 may also limit or restrict particular functions of machine 14, such as ground speed, power level, use of work implement, etc., based on stored or received data. For example, controller 28 may store or receive operator authorization data and permit usage of machine 14 based on the data. Similarly, controller 28 may store or receive skill level and/or experience level data relating to one or more operators and, and may limit or restrict functions of machine 14 based on the data (e.g., a first operator may be authorized for a first ground speed, and a second operator may be authorized for a second ground speed).

Console 30 may be located inside operator station 38 of machine 14, and may include a data entry module 40 for manually receiving data from the operator and a monitor for displaying information to the operator. Data entry module 40 may include a keyboard, mouse, touchscreen, directional pad, selector buttons, or any other suitable features for recording manually entered data. The data received via data entry module 40 may include various operator preferences such as, for example, a seat position, an engine speed, a transmission gear, a lighting setting, a climate control setting, etc. Data entry module 40 may also receive observed information from the operator, such as information associated with worksite 12, machine 14, and/or the operator. The operator may record this information into a physical or electronic log book (not shown) located within machine 14 during or after a work shift. In some cases, data from data entry module 40 may automatically be combined with data captured by controller 28. For example, operator input regarding a type and criticality of a worksite defect may be coordinated with a geographical location of machine 14, a condition measured at the time that the observed data was input, and the name of the operator working with machine 14 at the time the defect was encountered.

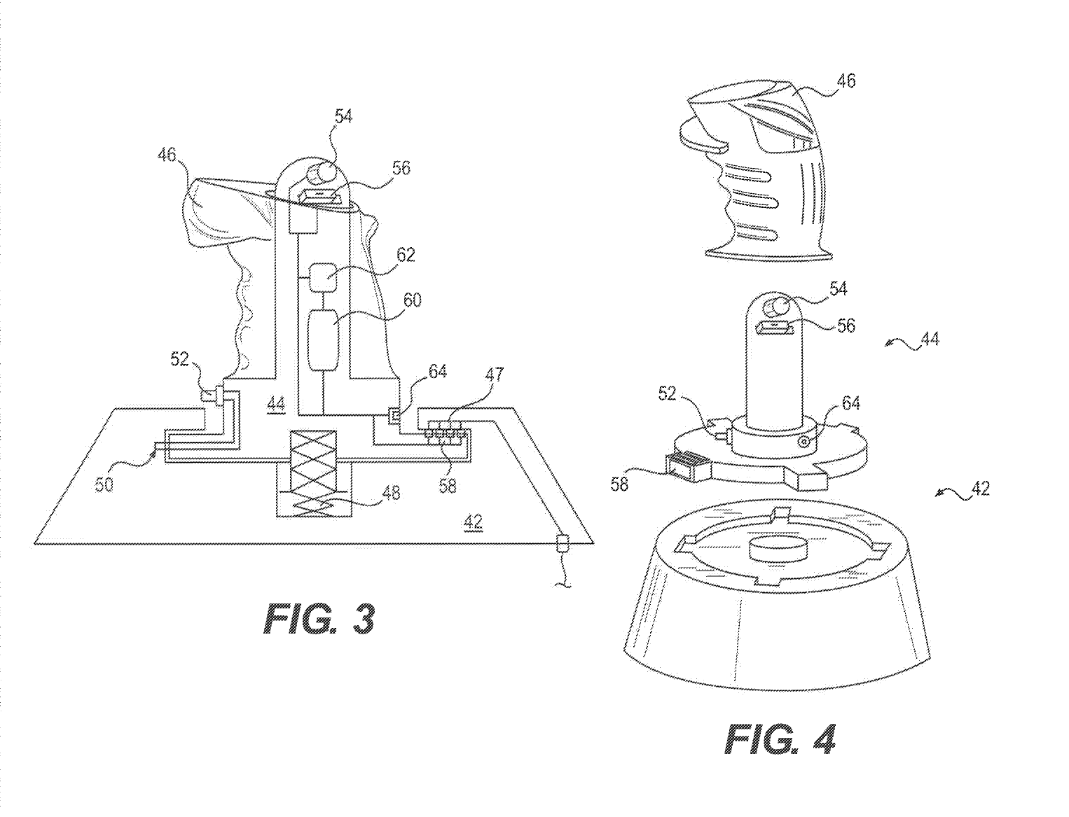

FIGS. 3 and 4 show an exemplary removable control device 34 connected to a receiver 42. Although removable control device 34 may be embodied as a joystick, it is contemplated that removable control device 34 may be another type of control device for controlling machines such as, for example, a steering wheel, a lever, a yoke, etc. Removable control device 34 may be connectable to receiver 42, and may include a base 44 that mechanically and electronically engages receiver 42 and a grip 46 connectable to base.

Receiver 42 may be integrated within console 30 and shaped to receive removable control device 34. For example, receiver 42 may be incorporated into an armrest of an operator seat, a dashboard, an instrument panel, or another part of operator station 36 (referring to FIG. 2). An electronic connector 47 within console 30 may engage removable control device 34 and provide an electrical connection between controller 28 and data entry module 40. A spring 48 or other resilient member within receiver 42 may compress when removable control device 34 is connected to receiver 42, and assist subsequent removal of control device 34 from receiver 42.

Base 44 may be shaped to mechanically engage and lock into receiver 42 with a twisting motion or any other suitable engagement maneuver. A locking mechanism, such as a latch 50 or other suitable device, may removably connect base 44 to receiver 42. In the disclosed embodiment, a separate feature, for example, a button 52 or any other suitable device, may be configured to unlock base 44 from receiver 42. Base 44 may be movable in order to generate control signals for the machine. For example, base 44 may be tilted, turned, twisted, pulled, pushed, etc., after engagement with receiver 42 to generate signals that control movement of machine 14. Base 44 may also include one or more additional control features, such as a button 54 and a switch 56 for generating auxiliary control signals for the machine. Base 44 may include any number of additional control features. In the disclosed embodiment, base 44 includes a generally cylindrical portion extending upwardly from the bottom. However, in other embodiments, the upwardly extending portion may be rectangular, triangular, hexagonal, octagonal, star-shaped, or any other suitable shape. The shape of the upwardly extending portion may, by its geometry, may help the operator to locate the appropriate orientation for engaging base 44 to receiver 42.

Base 44 may include an electronic connector 58 configured to communicate control signals, data, and other information with controller 28 and data entry module 40 via electronic connector 47 in receiver. For example, electronic connector 58 may include electrical contacts, a USB or Micro-USB connector, low-range wireless communication devices (e.g. radio frequency identification), or any suitable connectors configured to transfer data and signals. Electronic connector 58 may additionally be configured to connect to a USB port or other type of port of a computer when base 44 is disengaged from receiver 42.

Base 44 may also include an embedded memory module 60 configured to electronically communicate with controller 28 and data entry module 40 via electronic connector 58. Memory module 60 may include a data storage device, such as memory, configured to send and receive data. Memory module 60 may include flash, compact flash, SD, USB, or any other suitable memory type, and may be accompanied, in some embodiments, by a power supply 62. Power supply 62 may include a battery or may include a connection to an external power source, such as an electrical grid, computer, or other electrical power supply device. For example, power supply 62 may be connectable to a power source via electronic connector 58 or by a separate charging port 64.

Grip 46 may be assembled with base 44 to form an operator interface device, for example, by sliding grip 46 over a portion of base 44. Grip may also be removable therefrom and used with the base of another control device of a similar or different type of machine. However, when assembled with base 44, grip 46 may be fixed in place with respect to base 44. That is, when grip 46 is assembled with base 44, grip 46 may not rotate or otherwise move with respect to base 44 when the operator manipulates removable control device 34 during control of machine 14.

To provide operators with a personalized, ergonomic interface device, grip 46 may be customized to fit a particular operator's hand using a 3-D printing process. However, any suitable process may be used to fabricated grip 46. Grip 46 may be customized in order to provide an ergonomic interface that includes features such as grooves, finger pads, ledges, recesses, raised surfaces, thumb pads, etc., that best match the unique ergonomic needs of each operator. In the disclosed embodiment, the exterior features of grip 46 may be produced during a process of customizing grip 46 for a particular operator. Accordingly, other grips may not appear the same or contain the same features. Further, because grip 46 may be fabricated using 3-D printing, grip 46 can include complicated or detailed features as needed for each individual operator. Similarly, because grip 46 may be fabricated using 3-D printing, the exterior surface of grip 46 may include specific ergonomic features while the interior surface of grip 46 can be shaped to accommodate base(s) 44 of different geometries (e.g. cylindrical, rectangular, triangular, hexagonal, octagonal, star-shaped, etc.) that may not be easily included using other fabrication techniques.

### INDUSTRIAL APPLICABILITY

The disclosed removable control device may be used in any machine application having an operator control interface and a data collection system, where it is beneficial to collect, store, and transfer data between the machine and a data network. The disclosed removable control device finds particular applicability within mobile machines, such as digging machines, having an operator control interface, such a joystick, and a controller and/or other devices for collecting data. Operations of exemplary removable control device 34 will now be described in detail.

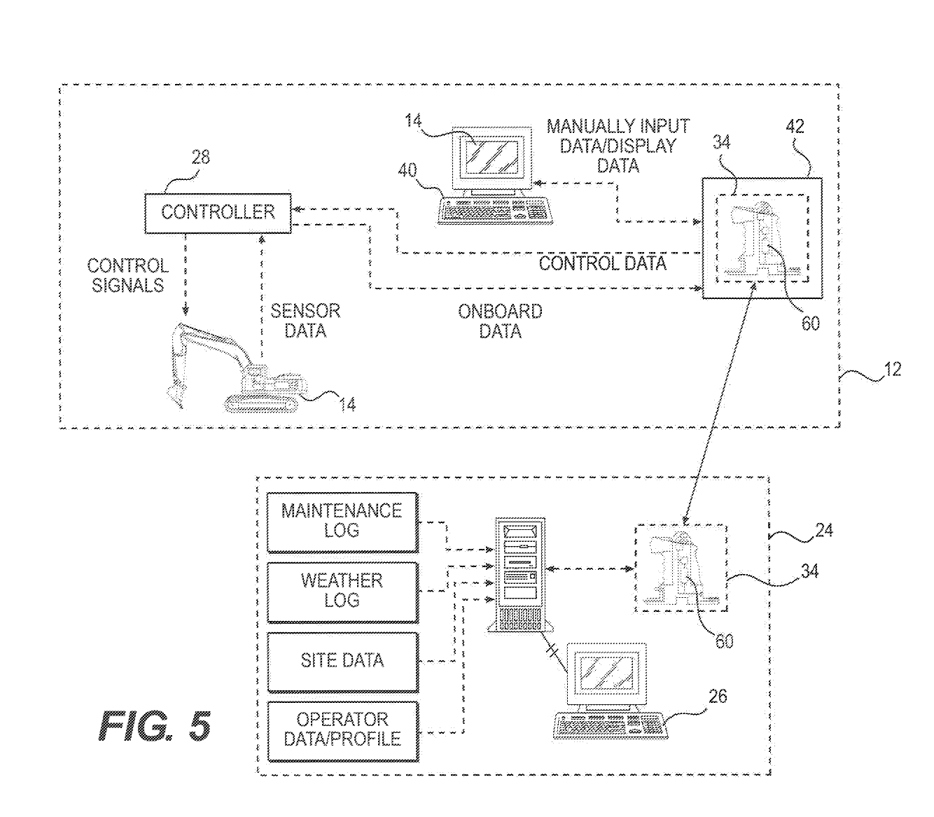

As illustrated in FIG. 5, during operation at worksite 12, onboard data from various sensors within machine 14 may be collected by controller 28. Onboard data from controller 28 may be transferred to memory module 60 within removable control device 34. Onboard data may include diagnostic data, such as recorded parameter information associated with specific components and/or systems of the machine. For example, diagnostic data could include engine temperature, engine and/or ground speed or acceleration, fluid characteristics (e.g., levels, contamination, viscosity, temperature, pressure etc.), fuel consumption, fuel type, exhaust emissions, exhaust aftertreatment system characteristics, braking conditions, transmission characteristics, air and/or exhaust pressures and temperatures, engine injection and/or ignition timings, wheel torque, rolling resistance, system voltage, etc.

Other types of onboard data may be generated or maintained by controller 28 such as, for example, time of day, date, and machine location (global and/or local). Diagnostic data may be coordinated with a geographical location of machine 14, date, and time. Some diagnostic data may be monitored directly, while other data may be derived or calculated by controller 28 from the monitored parameters. Diagnostic data may be used to determine performance data, if desired. Performance data may include, for example, payload information, efficiency information, productivity information, downtime, historical machine performance data, etc.

Controller 28 may also maintain machine-specific data, operator-specific data, and/or location-specific data. Machine-specific data may include identification data associated with a type of machine (e.g., digging, loading, dozing, etc.), a make and model of machine, a machine manufacture date or age, a usage or maintenance/repair history, etc. Operator-specific data may include an identification of a current operator, information about the current operator (e.g., a skill or experience level, an authorization level, an amount of time logged during a current shift, a usage history, productivity, operator-specific tasks, goals, and/or instructions etc.), a history of past operators, etc. Site-specific data may include a task currently being performed by the operator, a location authorization at worksite 12, a current location at worksite 12, a location history, a material composition at a particular area of worksite 12, etc.).

During operation, operators may also manually transfer data to memory module 60 via data entry module 40. The data received via data entry module 40 may include observed information associated with worksite 12, machine 14, and/or the operator. For example, the observed data may include a defect in the area of worksite 12 at which machine 14 is working, an amount of observed precipitation or visibility at worksite 12, an excessive vibration, sound, or smell of machine 14, or an identity and start time of the operator. The operator may record this information into a physical or electronic log book (not shown) located within machine 14 during or after a work shift. In some cases, data from console may automatically be combined with data captured by controller 28. For example, operator input regarding a type and criticality of a worksite detect may be coordinated with a geographical location of machine 14, a vibration measured at the time that the observed data was input, and the name of the operator working with machine 14 at the time the defect was encountered

When an operator's shift is over, removable control device 34 may be disconnected from machine 14 and taken to a computer connected to data network 24. Removable control device 34 may be connected to the computer, and data stored within memory module 60 may be downloaded to data network 24. Removable control device 34 may be connected to a computer at worksite 12, such as at worksite station 20, or to a computer remote from worksite 12, such as a central station computer 26. Removable control device 34 may also be connected to data network 24 via an internee connection from any suitable computer using proper credentials.

The operator may connect removable control device 34 to data network 24 by plugging electronic connector 58 into an appropriate port on a computer or other device connected to data network 24. While connected to data network 24, power supply 62 within removable control device 34 may be recharged with power supplied by the computer or other device. Alternatively, the operator may simultaneously (or when removable control device is not connected to data network) connect power supply 62 to an external source of power via charging port 64.

Computers in data network 24, such as central station computer 26, may analyze and store the various types of data collected from worksite 12. Part of this analysis may include indexing or trending the data according to different criteria, for example, according to a type of machine, machine identification, operator, and time. Data network may also be connected to other data sources and data bases that provide information, such as weather logs, machine maintenance logs, site data, and operator data. Such data may be coordinated with data from worksite 12 and analyzed together.

Data network 24 may contain profiles for each operator that include regularly updated information about each operator. For example, an operator's personal identification information, authorizations, restrictions, skill level, experience level, time sheet information, instructions, etc., may be included in the profile. An operator's personal preferences for machine settings may also be included in his or her profile, such as seat and mirror positions, climate control settings, pedal positions, engine speeds, transmission gears, etc. The profile may list machines assigned to the operator, worksites where the operator has recently worked, is currently working, or is allowed to work. The information in an operator profile may be regularly updated on data network 24 whenever removable control device is connected to data network 24 or manually updated by an operator, supervisor, or anyone granted access to data network. For example, manually entered data may include personalized instructions, messages, task goals, alerts, technical notices, and other information. This information may be added to an operator's profile by a supervisor, machine technician, or other operator.

Data may also be uploaded to memory module 60 in removable control device 34 from data network 24 and shared with machine 14. For example, an operator's profile, machine information, site information, and any other information from data network 24 may be uploaded to memory module 60 in removable control device 34. Each operator may be assigned his or her own removable control device, which may be automatically updated by data network 24 whenever removable control device 34 is connected to data network 24. Removable control devices 34 may also be categorized and automatically updated by operator class, machine type, machine model, etc., and may not be assigned to a specific operator. Manually entered data may also be downloaded to removable control device 34 via a data entry module, such as a computer on data network 24.

When removable control device is reconnected to receiver 42 in machine 14, data within memory module 60 may be communicated to controller 28 and to the operator via monitor 32. Controller 28 may govern, assist, permit, deny, or otherwise control various functions of machine 14 based on data received from memory module 60. For example certain machine settings may be automatically adjusted based on the operator's personal preferences stored in memory module 60 when removable control device 34 is reconnected to machine 14. Also, controller 28 may not permit the startup of machine 14 unless operator identification can be verified from the data within memory module 60. In this way, machine theft may be reduced. Even after verifying the identity of the operator, controller 28 may limit or restrict certain aspects of machine operation based on the operator data in memory module 60. For instance, if an operator has a relatively lower skill or experience level or is participating in a training program, controller 28 may limit the speed with which the operator may drive machine 14 or restrict power and/or range aspects of operating machine 14.

Information displayed to the operator via monitor 32 may relate to machine 14, tasks goals, instructions, messages from a supervisor or other personnel, worksite 12, etc. For example, recent repairs to machine 14 or notes from technicians or other operators relating to machine performance may be displayed during operation. Specific instructions or task goals assigned to the operator or to machine 14 may also be displayed, which the operator may check off or update via data entry module throughout his or her shift.

Data relating to worksite 12 may also be displayed to the operator via monitor 32, such as a map or layout of worksite 12. Locations of worksite station 20, tools, materials, restrooms, entrances, exits, first-aid equipment, drinking water, etc, may be included in memory module 60 and displayed via monitor 32. Other worksite information such as local road maps, truck routs, speed limits, noise ordinances, etc. may also be stored in memory module 60 and displayed to the operator via monitor 32.

If an operator is instructed to operate a different machine or go to a different worksite, the operator may disconnect removable control device 34 and take it to the next machine or worksite. If the operator's next task requires the use of a different type of removable control device 34 (e.g., one designed for use with a particular type of machine), the operator may remove grip 46 from the previous removable control device and use it with the next device. As discussed above, grip 46 may be customized to fit a particular operator by a suitable fabrication process, such as a 3-D printing process.

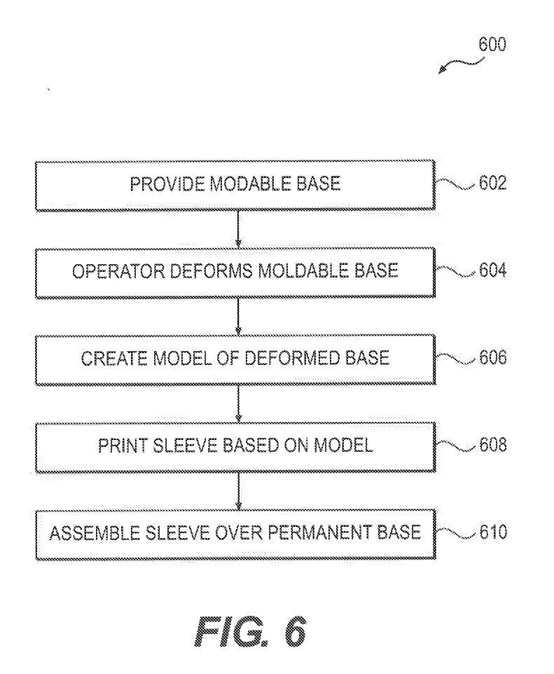

FIG. 6 shows an exemplary process 600 for printing a customized grip 46 for removable control device 34 of a machine. Process 600 may include providing a moldable base to an operator (Step 602). The moldable base may be in the shape of a universal base that can be used with several different types of machines. In one embodiment, the moldable base resembles base 44. The moldable base may also be in the shape of a particular type of base associated with a limited number of machines. An operator may be allowed to squeeze the moldable base and deform it according to the shape of his or her hand (Step 604). Step 604 may be repeated for the right and/or left hands of the operator.

A model of the deformed base may be created according to a suitable modeling process, such as CAD modeling or laser scanning (Step 606). The model may then be translated into code or instructions for 3-D printing, such as STL formatted instructions or instructions readable by any suitable 3-D printing system. Grip 46 may then be printed based on the model (Step 608) in the form of a sleeve or other shape suitable for attachment to a permanent base, for example to base 44. Grip 46 may then be assembled over the permanent base (Step 610).

What is claimed is:

1. A data management system for a machine, comprising:
a removable control device connectable to the machine and configured to generate control signals for the machine based on operator movement of the removable control device, the removable control device having a memory module; and
an onboard controller in communication with the memory module of the removable control device when the removable control device is connected to the machine, the controller being configured to communicate data with the memory module.

2. The data management system of claim 1, wherein the data includes operator identification data.

3. The data management system of claim 1, wherein the data includes an authorization level of an operator.

4. The data management system of claim 3, wherein the controller is configured to selectively allow startup and/or usage of the machine based on the authorization level.

5. The data management system of claim 1, wherein the data includes historical machine performance data.

6. The data management system of claim 1, wherein the data includes instructions, tasks, or goals for the operator.

7. The data management system of claim 1, wherein the removable control device includes a base that mechanically and electrically connects to the machine.

8. The data management system of claim 7, wherein the removable control device includes a removable grip connectable to the base.

9. The data management system of claim 7, wherein the memory module is embedded within the base. 10, The data management system of claim 8, wherein the grip is customized to the hand of an operator via 3-D printing.

11. An operator interface device for a machine, comprising:
a base mechanically and electrically connectable to the machine and movable by an operator to generate signals used to control movement of the machine; and
a memory module embedded within the base and configured to store historical data associated with at least one of the machine and the operator.

12. The operator interface device of claim 11, wherein the data includes operator identification data.

13. The operator interface device of claim 11, wherein the data includes an authorization level of an operator.

14. The operator interface device of claim 11, wherein the data includes diagnostic data of the machine.

15. The operator interface device of claim 11, wherein the data includes instructions, tasks, or goals for the operator.

16. The operator interface device of claim 11, wherein the memory module is configured to store data associated with a worksite.

17. The operator interface device of claim 11, further including a removable grip connectable to the base.

18. The operator interface device of claim 11, wherein the memory module is embedded within the base.

19. The operator interface device of claim 17, wherein the grip is customized to the hand of an operator via 3-D printing.

20. A method of fabricating a control device for a machine, wherein the method comprises:
providing a moldable base;
allowing an operator to deform the moldable base;
creating a model of the moldable base after deformation;
printing a grip based on the model; and
assembling the grip over a permanent base of the control device.
